(19) United States
(12) Patent Application Publication
(10) Pub. No.: US 2014/0006616 A1
(43) Pub. Date: Jan. 2, 2014

(54) METHOD AND APPARATUS FOR CATEGORIZING APPLICATION ACCESS REQUESTS ON A DEVICE

(71) Applicants: Imad AAD, Bottens (CH); Debmalya Biswas, Lausanne (CH); Gian Paolo Perrucci, Lausanne (CH)

(72) Inventors: Imad AAD, Bottens (CH); Debmalya Biswas, Lausanne (CH); Gian Paolo Perrucci, Lausanne (CH)

(73) Assignee: Nokia Corporation, Espoo (FI)

(21) Appl. No.: 13/538,348

(22) Filed: Jun. 29, 2012

(51) Int. Cl. G06F 15/173

(52) U.S. Cl. 709/225

(57) ABSTRACT

An approach is provided for categorizing user-initiated and application-initiated access to device resources. The monitoring platform determines one or more access requests by at least one application to one or more resources of at least one device. The monitoring platform processes and/or facilitates a processing of the one or more access requests to cause, at least in part, a categorization of the one or more access requests based, at least in part, on whether the one or more access requests were initiated by a user of the at least one device. The monitoring platform causes, at least in part, an assessment of the at least one application based, at least in part, on the categorization.

### BACKGROUND

Service providers and device manufacturers (e.g., wireless, cellular, etc.) are continually challenged to deliver value and convenience to consumers by, for example, providing compelling network services. One area of interest has been the development of increasingly complex and user-friendly applications for mobile devices (e.g., mobile phones and/or tablets). At the same time, an increasing number of malicious applications have been developed. By way of example, malicious applications are applications that collect private personal information about a device or the user of the device without the user's explicit consent and/or knowledge or with a consent that was given once by the user, but then forgotten. Previous systems (e.g., desktop anti-virus programs) have been developed to monitor the run-time behavior of applications with respect to accessing sensitive device resources to attempt to detect malicious behavior on part of the applications. However, these systems are unable to determine the impact of user interaction on the run-time behavior displayed by the applications. Accordingly, service providers and device manufactures face significant technical challenges in providing a service that monitors and reports the events profile of an application.

### SOME EXAMPLE EMBODIMENTS

Therefore, there is a need for an approach for categorizing user-initiated and application-initiated access to device resources.

According to one embodiment, a method comprises determining one or more access requests by at least one application to one or more resources of at least one device. The method also comprises processing and/or facilitating a processing of the one or more access requests to cause, at least in part, a categorization of the one or more access requests based, at least in part, on whether the one or more access requests were initiated by a user of the at least one device. The method further comprises causing, at least in part, an assessment of the at least one application based, at least in part, on the categorization.

According to another embodiment, an apparatus comprises at least one processor, and at least one memory including computer program code for one or more computer programs, the at least one memory and the computer program code configured to, with the at least one processor, cause, at least in part, the apparatus to determine one or more access requests by at least one application to one or more resources of at least one device. The apparatus is also caused to process and/or facilitate a processing of the one or more access requests to cause, at least in part, a categorization of the one or more access requests based, at least in part, on whether the one or more access requests were initiated by a user of the at least one device. The apparatus further causes, at least in part, an assessment of the at least one application based, at least in part, on the categorization.

According to another embodiment, a computer-readable storage medium carries one or more sequences of one or more instructions which, when executed by one or more processors, cause, at least in part, an apparatus to determine one or more access requests by at least one application to one or more resources of at least one device. The apparatus is also caused to process and/or facilitate a processing of the one or more access requests to cause, at least in part, a categorization of the one or more access requests based, at least in part, on whether the one or more access requests were initiated by a user of the at least one device. The apparatus further causes, at least in part, an assessment of the at least one application based, at least in part, on the categorization.

According to another embodiment, an apparatus comprises means for determining one or more access requests by at least one application to one or more resources of at least one device. The apparatus also comprises means for processing and/or facilitating a processing of the one or more access requests to cause, at least in part, a categorization of the one or more access requests based, at least in part, on whether the one or more access requests were initiated by a user of the at least one device. The apparatus further comprises means for causing, at least in part, an assessment of the at least one application based, at least in part, on the categorization.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of categorizing user-initiated and application-initiated access to device resources, according to one embodiment;

FIG. 2 is a diagram of the components of a monitoring platform/monitoring module, according to one embodiment;

FIGS. 3 and 4 are flowcharts of processes for categorizing user-initiated and application-initiated access to device resources, according to one embodiment;

FIGS. 5 and 6 are diagrams of example data flows as utilized in the processes of FIGS. 3 and 4, according to various embodiments;

FIG. 7 is a diagram of a user interface utilized in the processes of FIGS. 3 and 4, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for categorizing user-initiated and application-initiated access to device resources are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

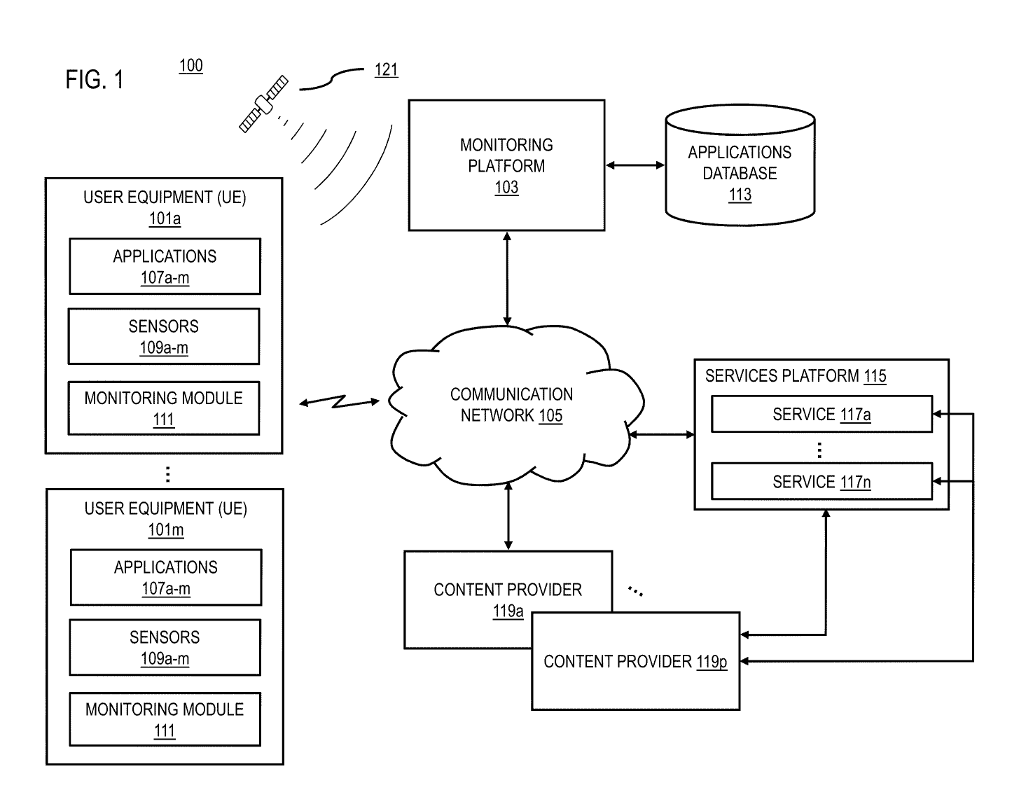

FIG. 1 is a diagram of a system capable of categorizing user-initiated and application-initiated access to device resources are disclosed, according to one embodiment. As previously discussed, one area of interest among service providers and device manufacturers has been the development of increasingly complex and user-friendly applications for mobile devices (e.g., mobile phones and/or tablets). At the same time, an increasing number of malicious applications have been developed that collect private personal information about a device or the user of the device without the user's explicit consent and/or knowledge or with a consent that was given once by the user, but then forgotten. Previous systems (e.g., desktop anti-virus programs) have been developed to monitor the run-time behavior of applications with respect to accessing sensitive device resources to attempt to detect malicious behavior. However, these systems are unable accurately distinguish between user-initiated (i.e., in response to an explicit user request) and application-initiated (i.e., without explicit user consent) accesses to device resources without first having access to the source code of the application. This is particularly relevant where service providers and device manufacturers only have access to the code of third-party applications in some intermediate compiled language. By way of example, an application (e.g., a weather application) may require access to location sensors (e.g., global positioning system (GPS) sensors) on the device (e.g., a mobile phone). In this example use case, the application may access the location sensors in response to a user-initiated action (e.g., clicking a button labeled “Get my Current GPS location”) or periodically without the user having any say or knowledge of the access frequency. In particular, the user-initiated action is considered non-malicious and the application-initiated access is considered malicious.

To address this problem, a system 100 of FIG. 1 introduces the capability to categorize user-initiated and application-initiated access to device resources. In one embodiment, the system 100 first determines one or more access requests by at least one application (e.g., a weather application, a Train Timetable application, etc.) to one or more resources (e.g., location resources, data resources, phone identity information, etc.) of at least one device (e.g., a mobile phone or a tablet). More specifically, the one or more device resources may include GPS receivers, sensors (e.g., an accelerometer, a compass, etc.), a file system, an address book or contacts, etc. associated with the device. By way of example, a user may launch a Train Timetable application on his or her mobile phone. The initial screen of this application may ask the user to input the “Station from” and the “Station to” that the user wants to travel between. As a result of clicking the “Station from” input field, a new screen is displayed that enables the user to either enter the name of the “Station from” or click a “GPS” button. If the user clicks the “GPS” button, then the application causes a location related access request to one or more device resources.

In one embodiment, the system 100 next causes, at least in part, a creation of at least one access log of the one or more access requests made by the at least one application during at least one run-time of the application. More specifically, the system 100 intercepts one or more accesses by the at least one application to the sensitive resources of the device (e.g., a GPS receiver) to create the at least one access log. Moreover, the at least one access log created by the system 100 includes, at least in part, the following information and/or format: timestamp, application (e.g., Train Timetable application), resource accessed (e.g., the accelerometer), and value (e.g., [x, y, z]). At substantially the same time, the system 100 also logs any user interaction events (e.g., a key press, a touch, etc.) and creates the at least one user interaction log that includes, at least in part, the following information and/or format: timestamp, application, and event type (e.g., a key press). Further, the system 100 determines the access and the user interaction logs during at least one run-time of the application because install-time verification (e.g., by static analysis) is unable to detect malicious behavior that may be caused by the application while the application is running. For instance, while a weather application may genuinely need access to location services on a device (i.e., an install-time declaration), if the application attempted to access the user's location every minute while it was running, the static analysis would not discover this intrusive quality of the application.

Even after the system 100 determines the at least one access log, the at least one user interaction log, or a combination thereof, the system 100 cannot simply filter out the access requests by the application in response to a user-initiated event. For example, even if the system 100 determined that a user interacted with an application just before an access request by the same application, the system 100 is unable to determine whether that specific user interaction event led to the access request by the application, which could lead to an unwanted high probability of false positives and/or negatives. Therefore, in one or more embodiments, the system 100 then determines at least one events profile for the at least one application based, at least in part, on the at least one access log, the at least one user interaction log, or a combination thereof. By way of example, the at least one events profile can be considered analogous to a virus signature in the context of anti-virus engines. In particular, the system 100 can model the at least one events profile as a finite state machine (FSM), a workflow, a Petri net, etc.

In one embodiment, the system 100 causes, at least in part, a modeling of the at least one events profile as a finite state machine (FSM) to capture the various access request patterns displayed by the application in response to one or more user interaction events. More specifically, the system 100 models the finite state machine so that M={Q, A, T} where: Q is the set of states corresponding to the execution states of the at least one application, labeled by the access requests that can be performed by the application in that state; A is the set of user interaction events; and T is the set of transitions with an event e, wherein A moves the system (i.e., an application execution) from state s₁ to s₂. Further, while there are multiple ways in which to model the at least one events profile (e.g., FSM, workflow, Petri net, etc.), the various embodiments of the present invention disclosed herein use the FSM model for the sake of explanation.

By way of example, the at least one events profile FSM may follow the screen flow of the at least one application. As previously discussed, at the initial screen of the Train Timetable application, the screen depicts input fields for designating the “Station from” and the “Station to.” At this instance, the FSM may capture that no location access was requested by the application. Once a user clicks the “Station from” input field, a new screen is displayed that includes an input field for entering the name of the “Station from” (e.g., New York Penn Station) and an adjacent “GPS” button. At this instance, the FSM captures the selection of the “Station from” input field as a touch event. If the user selects the “GPS” button, the application will make a location request of the one or more resources of the device (e.g., a GPS receiver). In particular, the at least one events profile FSM can capture whether the application made the access request in response to a single touch event (e.g., the user clicking the “Station from” input field) or in response to multiple touch events (e.g., the user also clicking the “GPS” button). If the Train Timetable application makes a location request after having received only one click (e.g., the first touch event), then that request can be captured by the at least one events profile FSM and later classified by the system 100 as a malicious request.

It is contemplated that the at least one events profile FSM for the at least one application may be determined by the system 100 in a number of ways. For example, the system 100 may determine the events profile FSM for a particular application from a centralized application store (e.g., Nokia Store), wherein the events profile FSM is generated by the application's one or more developers before the application is initially submitted for publication. In addition, the system 100 may determine the at least one events profile FSM based on one or more manual interactions with the application (e.g., by a user), wherein all of the possible application flows are executed so that the FSM can capture all of the potential user interactions. In another example use case, the system 100 may determine the events profile FSM through an automated process. More specifically, in one or more embodiments, the system 100 determines the at least one events profile based, at least in part, on one or more other event profiles, one or more other access logs, one or more other user interaction logs, or a combination thereof associated with the at least one application from one or more other users, historical information, or a combination thereof. By way of example, the system 100 may determine the one or more other logs (e.g., other access logs and/or other user interaction logs) using one or more crowdsourcing techniques. Once the system 100 collects the one or more other logs, the system 100 removes all user identification information associated with the logs and causes, at least in part, a transmission of the one or more other logs to a centralized application store and/or a trusted third-party entity to compute the corresponding events profile FSM for each application. The system 100 then determines the computed FSM for a particular application from the centralized application store and/or the trusted third-party entity.

In one embodiment, once the system 100 determines the one or more access requests by the at least one application (e.g., the Train Timetable application), the system 100 processes and/or facilitates a processing of the one or more access requests to cause, at least in part, a categorization of the one or more access requests based, at least in part, on whether the one or more access requests were initiated by a user of the at least one device (i.e., in response to an explicit user request). In contrast to user-initiated access requests, application-initiated access requests are a type or category of requests that are performed periodically by an application without the user having any say in the access frequency and/or are performed by the application without the explicit consent of the user or with a consent that was given once, but then forgotten. In one or more embodiments, for the reasons previously discussed, the system 100 causes, at least in part, the categorization of the one or more access requests during the at least one run-time of the at least one application based, at least in part, on the at least one events profile. In addition, the system 100 processes and/or facilitates a processing of the at least one access log, the at least one user interaction log, or a combination thereof to cause, at least in part, the categorization of the one or more access requests.

In certain embodiments, the system 100 causes, at least in part, an analysis of whether the one or more access requests are made via one or more user-specific application programming interfaces (APIs), one or more application-specific APIs, or a combination thereof, wherein the categorization the application is based, at least in part, on the analysis. By way of example, it is contemplated that an application requesting a location update of a device would use one of two different requestLocation( ) APIs. For example, a requestULocation( ) API could be used when a user of the application explicitly requests his or current location (e.g., clicking a “GPS” button) and a requestALocation( ) API could be used when an application, for example, would like to cache the user's current location in the background of the at least one device to better adapt its functionality when it is brought back into use.

In one embodiment, once the system 100 categorizes the one or more access requests based, at least in part, on whether the one or more access requests were initiated by a user, the system 100 causes, at least in part, an assessment of the at least one application based, at least in part, on the categorization. More specifically, the assessment by the system 100 includes, at least in part, an intrusiveness assessment, a privacy assessment, a security assessment, or a combination thereof associated with the at least one application. As previously discussed, in the example use case of the Train Timetable application, if the application makes a location request after having received only one click from the user (e.g., clicking the “Station from” input field), then the system 100 determines that the request and therefore the application is malicious. In contrast, if the access request is in response to a user clicking a button, for example, “Get my Current GPS location,” the system 100 determines that the request and therefore the application is non-malicious. In another example use case, if the application makes the one or more access requests for user location updates periodically without the user having any say in the access frequency, then the system 100 determines that this is a malicious access request and therefore a malicious application. Further, while an application (e.g., a weather application) may genuinely need access to location services on the at least one device (e.g., a mobile phone), the system 100 would assess the application as intrusive and therefore malicious if it attempts to access user location information every minute.

In one or more embodiments, the system 100 next causes, at least in part, a transmission of the at least one events profile (e.g., as a FSM model) to the at least one device based, at least in part, on an installation, an update, an initialization, or a combination thereof of the at least one application at the least one device. In one example use case, whenever a user installs a new application on his or her device (e.g., a mobile phone or a tablet), the system 100 can download the corresponding events profile FSM on or about the same time. In particular, it is contemplated that in certain embodiments (e.g., generating the FSM through an automated process) there may be a negligible delay after an application has been installed on the device before the corresponding FSM becomes available to the device.

In one or more embodiments, the system 100 then determines one or more access rights, one or more privacy policies, one or more security policies, or a combination thereof for the at least one application, the at least one device, or a combination thereof based, at least in part, on the assessment. Moreover, in one example use case, an application developer or a centralized application store may include the system 100's assessment in the description of the at least one application to provide users with an additional layer of information and/or protection by informing the users that the particular application will only access certain resources upon a user's request. As a result, the system 100 can assess and/or rate the at least one application in a user-independent fashion. Further, it is contemplated that the more users know and understand about the underlying processes of the at least one application, the more willing a user may be to allow the application access to one or more device resources and thereby enable an overall richer user experience.

As shown in FIG. 1, the system 100 comprises one or more user equipment (UE) 101a-101m (e.g., mobile phones and/or tablets) (also collectively referred to as UEs 101) having connectivity to a monitoring platform 103 via a communication network 105. The UEs 101 include or have access to one or more applications 107a-107m (also collectively referred to as applications 107). By way of example, the applications 107 may include a weather application, a Train Timetable application, mapping and/or navigation applications, media applications, social networking applications, etc. Moreover, the UEs 101 also include one or more sensors 109a-109m (e.g., a GPS receiver, an accelerometer, etc.) (also collectively referred to as sensors 109). In addition, the UEs 101 include a monitoring module 111 that has substantially similar capabilities as the monitoring platform 103 to locally intercept one or more access requests by the applications 107 and/or to enforce any privacy/security policies determined by the system 100.

In one embodiment, the monitoring platform 103/monitoring module 111 may include or be associated with at least one applications database 113, which may exist in whole or in part within the monitoring platform 103 or the monitoring module 111. The applications database 113 may include one or more access logs, one or more user interaction logs, one or more application events profiles, one or more finite state machines, or a combination thereof. In addition, the applications database 113 may also include one or more assessments, one or more access rights, one or more privacy policies, one or more security policies, or a combination thereof for the applications 107, the UEs 101, or a combination thereof. The UEs 101 are also connected to a services platform 115 via the communication network 105. The services platform 115 (e.g., a centralized application store) includes one or more services 117a-117n (also collectively referred to as services 117). The services may include a wide variety of services such as content provisioning services for the applications 107 (e.g., train schedules, updated weather information, location-based information, etc.). In one embodiment, the services 117 may also include a service for computing one or more finite state machines for one or more applications 107. In addition, the UEs 101, the services platform 115, and the services 117 are also connected to one or more content providers 119a-119p (also collectively referred as content providers 119) via the communication network 105. The content providers 119 also may provide a wide variety of content (e.g., one or more applications 107) to the components of the system 100.

In one embodiment, the applications 107 (e.g., a Train Timetable application, a weather application, etc.) utilize location-based technologies (e.g., GPS, cellular triangulation, Assisted GPS (A-GPS), etc.) to make a request to the services 117 or the content providers 119 for location-based data (e.g., weather conditions) based on a position relative to a UE 101. For example, the UEs 101 may include a GPS receiver to obtain geographic coordinates from the satellites 121 to determine its current position.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 101 are any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UEs 101 can support any type of interface to the user (such as “wearable” circuitry, etc.).

In one embodiment, the monitoring platform 103/monitoring module 111 first determines one or more access requests by at least one application 107 (e.g., a weather application, a Train Timetable application, etc.) to one or more resources (e.g., location resources, data resources, phone identity, etc.) of a UE 101 (e.g., a mobile phone or a tablet). While the monitoring platform 103 and the monitoring module 111 are interchangeable, the various embodiments of the present invention disclosed herein mainly reference the monitoring platform 103 for the sake of explanation. In particular, the one or more device resources may include the sensors 109 (e.g., a GPS receiver, an accelerometer), a file system, an address book or contacts, etc. associated with the UE 101. As previously discussed, a user may launch a Train Timetable application 107 on his or her UE 101. The initial screen of the application 107 may ask the user to input the “Station from” and the “Station to” that the user wants to travel between. As a result of clicking the “Station from” input field, a new screen is displayed that enables the user to either enter the name of the “Station from” or click a “GPS” button. If the user clicks the “GPS” button, then the application 107 causes a location related access request to one or more resources of the UE 101.

In one embodiment, the monitoring platform 103 next causes, at least in part, a creation of at least one access log of the one or more access requests made by the application 107 during at least one run-time. More specifically, the monitoring platform 103 intercepts one or more accesses by the application 107 to the sensitive resources of a UE 101 (e.g., a GPS receiver) to create the at least one access log. At substantially the same time, the monitoring platform 103 also logs any user interactions (e.g., a key press, a touch, etc.) and consequently creates at least one user interaction log. Further the monitoring platform 103 determines the access and user interaction logs during at least one run-time of the application 107 because install-time verification is unable to detect malicious behavior that may be caused by the application 107 while the application 107 is running.

In one or more embodiments, the monitoring platform 103 then determines at least one events profile for the application 107 based, at least in part, on the at least one access log, the at least one user interaction log, or a combination thereof. As previously discussed, the at least one events profile can be considered analogous to a virus signature in the context of anti-virus engines. More specifically, in one embodiment, the monitoring platform 103 causes, at least in part, a modeling of the at least one events profile as a FSM to capture the various access request patterns displayed by the application 107 in response to one or more user interaction events. Moreover, the at least one events profile FSM may be determined by the monitoring platform 103 in a number of ways. For example, in one embodiment, the monitoring platform 103 may determine the events profile FSM for a particular application 107 from a centralized application store (e.g., Nokia Store) or based on one or manual interactions with the application 107 (e.g., by a user). As previously discussed, while there are a number of ways to model the at least one events profile (e.g., FSM, workflow, Petri net, etc.), the various embodiments of the present invention disclosed herein use the FSM model for the sake of explanation.

In another example use case, the monitoring platform 103 may determine the at least one events profile FSM through an automated process. More specifically, in one or more embodiments, the monitoring platform 103 determines the at least one events profile FSM based, at least in part, on one or more other event profiles, one or more other access logs, one or more other interaction logs, or a combination thereof. By way of example, the monitoring platform 103 may determine the one or more other logs (e.g., other access logs and/or other user interaction logs) using one or more crowdsourcing techniques. Once the monitoring platform 103 collects the one or more other logs, the monitoring platform 103 removes all user identification information associated with the logs and causes, at least in part, a transmission of the one or more logs to the services platform 115 or the content providers 119 to compute the corresponding events profile FSM for each application 107. The monitoring platform 103 subsequently determines the FSM for a particular application from the services platform 115 or the content providers 119.

In one embodiment, once the monitoring platform 103 determines the one or more access requests by the at least one application 107, the monitoring platform 103 processes and/or facilitates a processing of the one or more access requests to cause, at least in part, a categorization of the one or more access requests based, at least in part, on whether the one or more access requests were initiated by a user of the at least one device (i.e., in response to an explicit user request). Moreover, the monitoring platform 103 causes, at least in part, the categorization of the one or more access requests during the at least one run-time of the application 107 for the reasons previously discussed. In addition, the monitoring platform 103 processes and/or facilitates a processing of the at least one access log, the at least one user interaction log, or a combination thereof to cause, at least in part, the categorization of the one or more access requests by the application 107.

In certain embodiments, the monitoring platform 103 causes, at least in part, an analysis of whether the one or more access requests are made via one or more user-specific APIs, one or more application-specific APIs, or a combination thereof, wherein the categorization of the one or more access requests is based, at least in part, on the analysis. In one embodiment, once the monitoring platform 103 categorizes the one or more access requests based, at least in part, on whether the one or more access requests were initiated by a user, the monitoring platform 103 causes, at least in part, an assessment of the application 107 based, at least in part, on the categorization. In particular, the assessment by the monitoring platform 103 includes, at least in part, an intrusiveness assessment, a privacy assessment, a security assessment, or a combination thereof associated with the application 107. As previously discussed, in the example use case of the Train Timetable application 107, if the application 107 makes a location request after having received only one click from the user (e.g., clicking the “Station from” input field), then the monitoring platform 103 determines that the request and therefore the application 107 is malicious. In contrast, if the access request is in response to a user clicking a button, for example, “Get my Current GPS location,” the monitoring platform 103 determines that the request and therefore the application 107 is non-malicious.

In one or more embodiments, the monitoring platform 103 next causes, at least in part, a transmission of the at least one events profile (e.g., as a FSM model) to a UE 101 based, at least in part, on an installation, an update, an initialization, or a combination thereof of the application 107 at a UE 101. In one example use case, whenever a user installs a new application 107 on a UE 101 (e.g., a mobile phone or a tablet), the monitoring platform 103 can download the corresponding events profile FSM on or about the same time. In one embodiment, the monitoring platform 103 then determines one or more access rights, one or more privacy policies, or a combination thereof for the application 107, a UE 101, or a combination thereof based, at least in part, on the assessment. Moreover, in one example use case, the services platform 115 (e.g., a centralized application store) can include the assessment by the monitoring platform 103 in its description of the application 107 to provide users with an additional layer of information and/or protection by informing the users that the application 107 will only access certain resources upon a user's request.

By way of example, the UEs 101, monitoring platform 103, the services platform 115, the content providers 119, the satellites 121 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

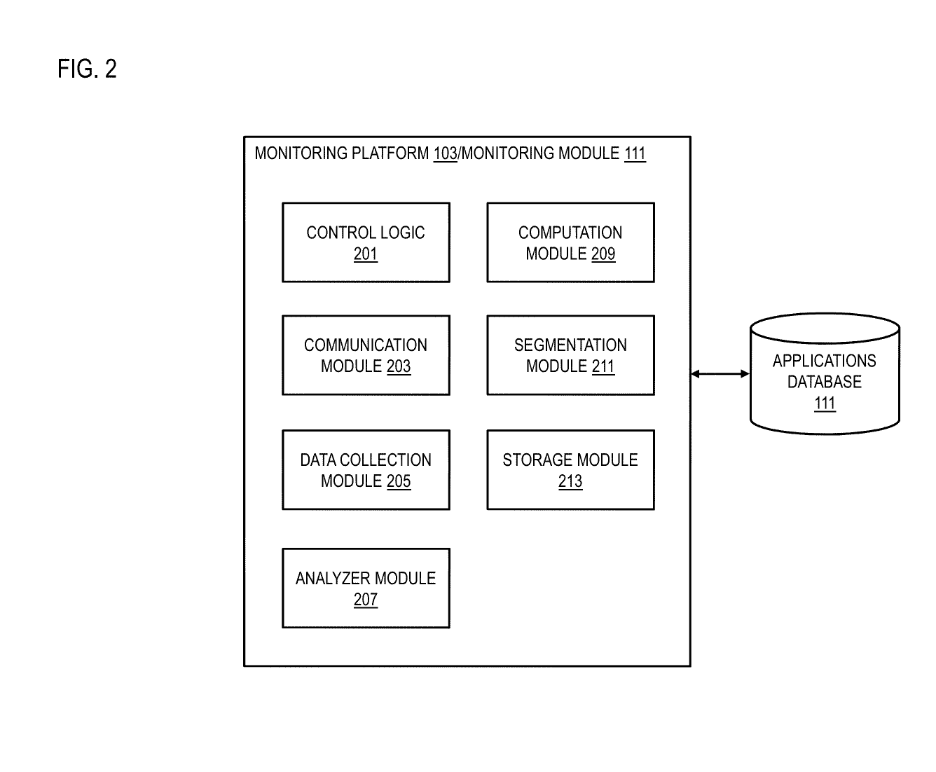

FIG. 2 is a diagram of the components of a monitoring platform 103/monitoring module 111, according to one embodiment. Again, while the monitoring platform 103 and the monitoring module 111 are interchangeable, the various embodiments of the present invention disclosed herein mainly reference the monitoring platform 103 for the sake of explanation. By way of example, the monitoring platform 103 includes one or more components for categorizing user-initiated and application-initiated access to device resources. It is contemplated that the functions of these components may be combined in one or more components or performed by other components of equivalent functionality. In this embodiment, the monitoring platform 103 includes a control logic 201, a communication module 203, a data collection module 205, an analyzer module 207, a computation module 209, a segmentation module 211, and a storage module 213.

The control logic 201 oversees tasks, including tasks performed by the communication module 203, the data collection module 205, the analyzer module 207, the computation module 209, the segmentation module 211, and the storage module 213. For example, although the other modules may perform the actual task, the control logic 201 may determine when and how those tasks are performed or otherwise direct the other modules to perform the task. The control logic 201 may also be used to determine the one or more access rights, the one or more privacy policies, the one or more security policies, or a combination thereof for t at least one application (e.g., a weather application, a Train Timetable application, etc.), at least one device (e.g., a mobile phone or a tablet), or a combination thereof based, at least in part, on the assessment by the analyzer module 207 of the at least one application.

The communication module 203 is used for communication between the UEs 101, the monitoring platform 103, the applications 107, the sensors 109, the applications database 113, the services platform 115, the services 117, the content providers 119, and the satellites 121. The communication modules 203 may also be used to communicate commands, requests, data, etc. The communication module 203 also may be used to transmit the at least one events profile to the at least one device (e.g., a mobile phone) based, at least in part, on an installation, an update, an initialization, or a combination thereof of the at least one application (e.g., a Train Timetable application) at the at least one device. The communication module 203 may also be used in connection with the data collection module 205 to determine one or more other events profiles, one or more other access logs, one or more other user interaction logs, or a combination thereof associated with the at least one application from one or more other users, historical information, or a combination thereof.

The data collection module 205 is used to determine one or more access requests by the at least one application (e.g., a weather application, a Train Timetable application, etc.) to one or more resources of at least one device (e.g., a GPS receiver, sensors, a file system, an address book or contacts, etc.). The data collection module 205, in connection with the analyzer module 207, may also be used to create at least one access log of the one or more access requests and at least one user interaction log of one or more user interaction events occurring during the at least one run-time of the at least one application. As previously discussed, the data collection module 205 also may be used to determine the one or more other events profiles, the one or more other access logs, the one or more other user interactions, or a combination thereof.

The analyzer module 207 is used to determine at least one events profile for the at least one application based, at least in part, on the at least one access log, the at least one user interaction log, or a combination thereof. The analyzer module 207, in connection with the data collection module 205 and/or the segmentation module 211, may also be used to determine the run-time of the at least one application. The analyzer module 207, in connection with the communication module 203, also may be used to cause, at least in part, an analysis of whether the one or more access requests are made via one or more user-specific APIs (e.g., a requestULocation( ) API), one or more application-specific APIs (e.g., a requestALocation( ) API), or a combination thereof. Further, the analyzer module 207 may also be used to cause, at least in part, an assessment of the at least one application based, at least in part, on the categorization of the one or more access requests determined by the segmentation module 211.

The computation module 209 is used to model the at least one events profile as a finite state machine. In particular, the computation module 209 models the FSM so that M={Q, A, T} where: Q is the set of states corresponding to the execution states of the at least one application, labeled by the access requests that can be performed by the application in that state; A is the set of user interaction events; and T is the set of transitions with an event e, wherein A moves the system (i.e., an application execution) from state s₁ to s₂.

The segmentation module 211 is used to process and/or facilitate a processing of the one or more access requests based, at least in part, on whether the one or more access requests were initiated by a user of the at least one device. The segmentation module 211 may also be used to process and/or facilitate a processing of the at least one access log, the at least one user interaction log, or a combination thereof to cause, at least in part, the categorization of the one or more access requests by the at least one application. As previously discussed, the segmentation module 211 also may be used to cause, at least in part, the categorization of the one or more access requests during the at least one run-time of the at least one application.

The storage module 213 is used to manage the storage of the one or more access logs, the one or more user interaction logs, the one or more application events profiles, the one or more finite state machines, or a combination thereof stored in the applications database 113. The storage module 213 may also be used to manage the storage of the one or more assessments, the one or more access rights, the one or more privacy policies, the one or more security policies, or a combination thereof for the at least one application, the at least one device, or a combination thereof.

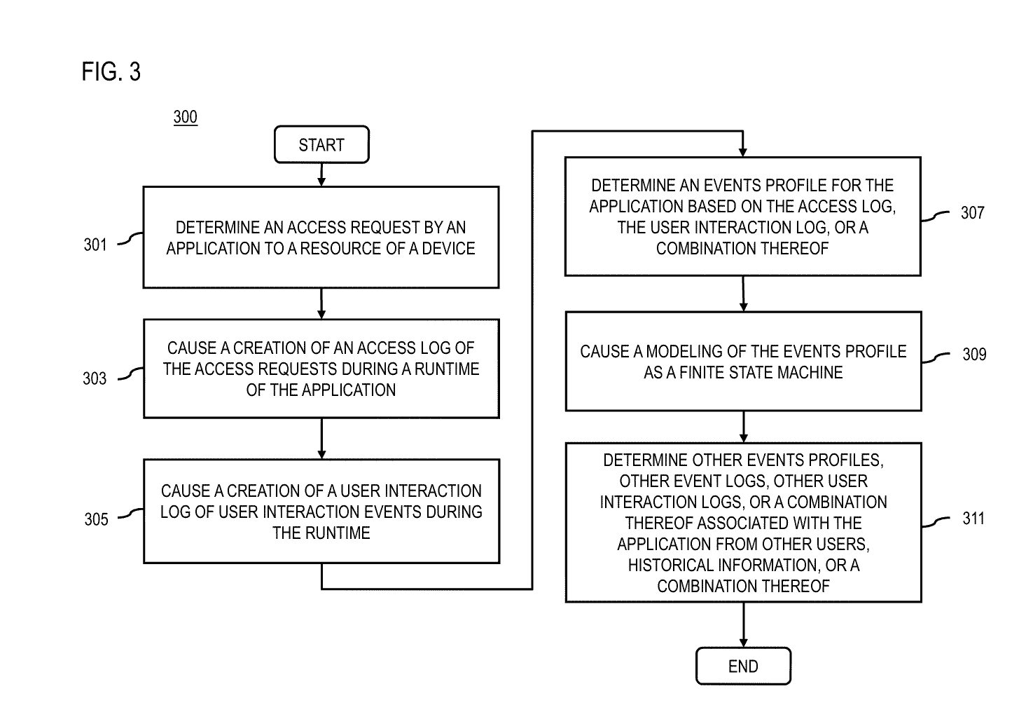

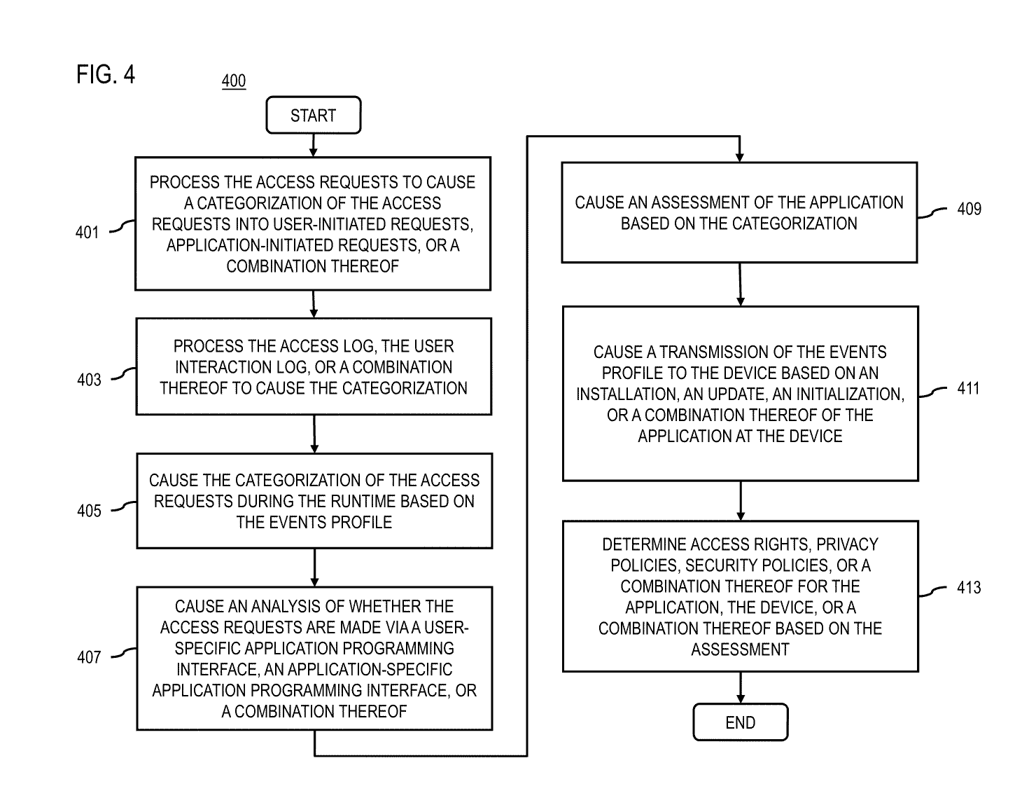

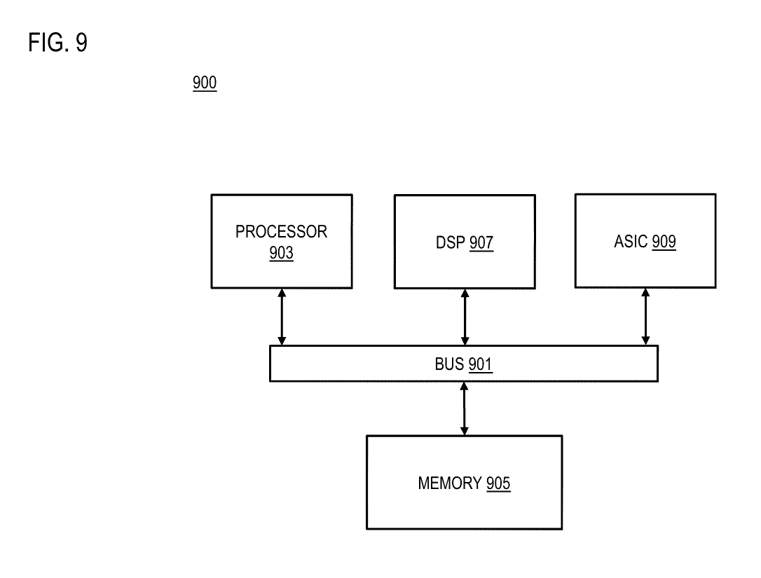

FIGS. 3 and 4 are flowcharts of processes for categorizing user-initiated and application-initiated access to device resources, according to one embodiment. FIG. 3 depicts a process 300 of determining one or more access requests by at least one application. In one embodiment, the monitoring platform 103/monitoring module 111 performs the process 300 and is implemented in, for instance, a chip set including a processor and a memory as shown in FIG. 9. In step 301, monitoring platform 103 determines one or more access requests by at least one application to one or more resources of at least one device. By way of example, an access request is an attempt by an application (e.g., a weather application, a Train Timetable application, etc.) to access private personal information about the device, the user of the device, or a combination thereof. In particular, the one or more device resources may include GPS receivers, sensors (e.g., an accelerometer, a compass, etc.), a file system, an address book or contacts, etc. associated with the device (e.g., a mobile phone or a tablet). As previously discussed, in one example use case, a user may launch a Train Timetable application on his or her mobile phone. The initial screen of this application may ask the user to input the “Station from” and the “Station to” that the user wants to travel between. As a result of clicking the “Station from” input field, a new screen is displayed that enables the user to either enter the name of the “Station from” or click a “GPS” button. If the user clicks the “GPS” button, then the application causes a location related access request to one or more resources of the device.

In step 303, the monitoring platform 103 causes, at least in part, a creation of at least one access log of the one or more access requests during at least one run-time of the at least one application. More specifically, the monitoring platform 103 intercepts one or more accesses by the at least one application (e.g., a Train Timetable application) to the sensitive resources of the device (e.g., a GPS receiver) to create the at least one access log. Moreover, the at least one access log created by the monitoring platform 103 includes, at least in part, the following information: timestamp, application (e.g., Train Timetable application), resource accessed (e.g., the accelerometer), and value (e.g., [x, y, z]). In step 305, the monitoring platform 103 causes, at least in part, a creation of at least one user interaction log of one or more user interaction events occurring during the at least one run-time. In particular, the monitoring platform 103 logs any user interaction events (e.g., a key press, a touch, etc.) and creates the at least one user interaction log that includes, at least in part, the following information and/or format: timestamp, application, and event type (e.g., a key press, a touch, etc.). Further, in steps 303 and 305, the monitoring platform 103 determines the access and the user interaction logs during at least one run-time of the application because install-time verification (e.g., by static analysis) is unable to detect malicious behavior that may be caused by the application while the application is running.

In step 307, the monitoring platform 103 determines at least one events profile for the at least one application based, at least in part, on the at least one access log, the at least one user interaction log, or a combination thereof, wherein the categorization is based, at least in part, on the at least one events profile. By way of example, the application events profile can be considered analogous to a virus signature in the context of anti-virus engines. In one or more embodiments, the monitoring platform 103 determines the events profile because even after the monitoring platform 103 determines the at least one access log, the at least one user interaction log, or a combination thereof, the monitoring platform 103 cannot simply filter out the access requests by the application in response to a user-initiated event without a high probability of false positives and/or negatives. In particular, the monitoring platform 103 can model the at least one events profile as a FSM, a workflow, a Petri net, etc.

In step 309, the monitoring platform 103 causes, at least in part, a modeling of the at least one events profile as a finite state machine. More specifically, the monitoring platform 103 models the user interaction profile as an FSM to capture the possible access request patters displayed by the at least one application in response to one or more user interaction events. Further, the monitoring platform 103 models the FSM so that that M={Q, A, T} where: Q is the set of states corresponding to the execution states of the at least one application, labeled by the access requests that can be performed by the application in that state; A is the set of user interaction events; and T is the set of transitions with an event e, wherein A moves the system (i.e., an application execution) from state s₁ to s₂. In particular, the monitoring platform 103 may determine the FSM from a number of sources. For example, the monitoring platform 103 may determine the FSM for a particular application from a centralized application store (e.g., Nokia Store), wherein the FSM is generated by the one or more developers of the application prior to the submission of the application to the application store. The monitoring platform 103 may also determine the FSM from the centralized application store or a trusted third-party entity, wherein the FSM is generated based, at least in part, on one or more crowdsourcing techniques. In certain embodiments, the monitoring platform 103 may determine the FSM based on one or more manual interactions with the application (e.g., by a user), wherein all of the possible application flows are executed so that the FSM can capture all of the potential user interactions. Again, while there are a number of ways to model the at least one events profile (e.g., FSM, workflow, Petri net, etc.), the various embodiments of the present invention disclosed herein use the FSM model for the sake of explanation.

As previously discussed, the at least one events profile FSM may follow the screen flow of an application. By way of example, at the initial screen of the Train Timetable application, for example, the screen depicts input fields for designating the “Station from” and the “Station to.” At this instance, the FSM may capture that no location access was requested by the application. Once a user clicks the “Station from” input field, a new screen is displayed that includes an input field for typing the name of the “Station from” (e.g., New York Penn Station) and an adjacent “GPS” button. At this instance, the FSM captures the user's first touch event. If the user selects the “GPS” button, the application will make a location request of the one or more resources of the device (e.g., a GPS receiver). In particular, the at least one events profile FSM can capture whether the application made the access request in response to a single touch event (e.g., the user clicking the “station from” input field) or in response to multiple touch events. If the Train Timetable application makes a location request after having received only one click (e.g., the first touch event), then that request can be captured by the at least one events profile FSM and later classified by the system 100 as a malicious request.

In step 311, the monitoring platform determines one or more other events profiles, one or more other access logs, one or more other user interaction logs, or a combination thereof associated with the at least one application from one or more other users, historical information, or a combination thereof, wherein the at least one events profile is based, at least in part, on the one or more other events profiles, the one or more other event logs, the one or more other user interaction logs, or a combination thereof. As previously discussed, in one example use case, the monitoring platform 103 may determine the one or more other logs (e.g., other access logs and/or other user interaction logs) using one or more crowdsourcing techniques. By way of example, once the monitoring platform 103 collects the one or more other logs, the monitoring platform 103 removes all user identification information associated with the logs and causes, at least in part, a transmission of the one or more other logs to a centralized application store (e.g., Nokia Store) or another trusted third-party entity to compute the corresponding events profile FSM for each application. The monitoring platform 103 then determines the FSM for a particular application from the centralized application and/or trusted third-party entity.

FIG. 4 depicts a process 400 of categorizing and assessing the one or more access requests. In one embodiment, the monitoring platform 103 performs the process 400 and is implemented in, for instance, a chip set including a processor and a memory as shown in FIG. 9. In step 401, the monitoring platform 103/monitoring module 111 processes and/or facilitates a processing of the one or more access requests to cause, at least in part, a categorization of the one or more access requests based, at least in part, on whether the one or more access requests were initiated by a user of the at least one device. By way of example, a user-initiated access request can be in response to a user clicking a button, for example, “Get my Current GPS location” or the “GPS” button in the Train Timetable application example. In contrast, application-initiated access requests are requests that are performed periodically by an application without the user having any say in the access frequency and/or without the explicit user consent or with a consent that was given once, but then forgotten.

In step 403, the monitoring platform 103 processes and/or facilitates a processing of the at least one access log, the at least one user interaction log, or a combination thereof to cause, at least in part, the categorization. As previously discussed, the monitoring platform 103 intercepts one or more accesses by the at least one application to the sensitive resources of the at least one device (e.g., a GPS receiver) to create the at least one access log. Whereas, the monitoring platform 103 logs any user interaction events (e.g., a key press, a touch, etc.) to create the at least one user interaction log. Based on the at least one access log and the at least one user interaction log, the monitoring platform 103 can determine whether the one or more underlying access requests were user-initiated (i.e., in response to an explicit user request) or application-initiated access requests (i.e., without explicit user consent).

In step 405, the monitoring platform 103 causes, at least in part, the categorization of the one or more access requests during the at least one run-time based, at least in part, on the at least one events profile. In particular, as previously discussed, the monitoring platform 103 categorizes the one or the access requests during the at least one run-time because install-time verification (e.g., by static analysis) is unable to detect malicious behavior that may be caused by the application while the application is running Therefore, unless the one or more access requests are categorized during at least one run-time of the application, the monitoring platform 103 may erroneously categorize the at one or more access requests.

In step 407, monitoring platform 103 cause, at least in part, an analysis of whether the one or more access requests are made via one or more user-specific application programming interfaces, one or more application-specific application programming interfaces, or a combination thereof, wherein the categorization is based, at least in part, on the analysis. By way of example, it is contemplated that an application requesting a location update of a device would use one of two different requestLocation( ) APIs. For example, a requestULocation( ) API could be used when a user of the application explicitly requests his or current location (e.g., clicking a “GPS” button) and a requestALocation( ) API could be used when an application, for example, would like to cache the user's current location in the background of the at least one device to better adapt its functionality when it is brought back into use. As a result, the monitoring platform 103 may cause, at least in part, a categorization of the one or more access requests depending on which requestLocation( ) API was used by the application.

In step 409, the monitoring platform 103 causes, at least in part, an assessment of the at least one application based, at least in part, on the categorization. More specifically, the assessment by the monitoring platform 103 includes, at least in part, an intrusiveness assessment, a privacy assessment, a security assessment, or a combination thereof associated with the at least one application. By way of example, in the example use case of the Train Timetable application, if the application makes a location request after having received only one click form the user (e.g., clicking the “Station from” input field), then the monitoring platform 103 assesses the request and therefore the application as malicious. In contrast, if the access request is in response to a user clicking a button, for example, “Get my Current GPS location,” the monitoring platform 103 assesses the request and therefore the application as non-malicious. In another example use case, if the application makes the one or more access requests for user location updates periodically without the user having any say in the access frequency, then the monitoring platform 103 determines that this is a malicious access request and therefore a malicious application. Further, while an application (e.g., a weather application) may genuinely need access to location services on the at least one device (e.g., a mobile phone), the monitoring platform 103 would assess the application as intrusive and therefore malicious if it attempts to access user location information every minute.

In step 411, the monitoring platform 103 causes, at least in part, a transmission of the at least one events profile to the at least one device based, at least in part, on an installation, an update, an initialization, or a combination thereof of the at least one application at the at least one device. By way of example, whenever a user installs a new application on his or her device (e.g., a mobile phone or a tablet), the monitoring platform 103 can download the corresponding events profile FSM on or about the same time. In particular, it is contemplated that in certain embodiments (e.g., generating the FSM through an automated process) there may be a negligible delay after an application has been installed on the device before the corresponding FSM becomes available to the device.

In step 413, the monitoring platform 103 determines one or more access rights, one or more privacy policies, one or more security policies, or a combination thereof for the at least one application, the at least one device, or a combination thereof based, at least in part, on the assessment. By way of example, an application developer or a centralized application store may include the assessment by the monitoring platform 103 in the description of the at least one application to provide users with an additional layer or information and/or protection by informing them the users that the particular application will only access certain resources upon a user's request. For example, it is contemplated that the more a user knows and understands about the underlying processes of the at least one application, the more willing the user may be to allow the application access to one or more device resources and thereby enable an overall richer user experience.

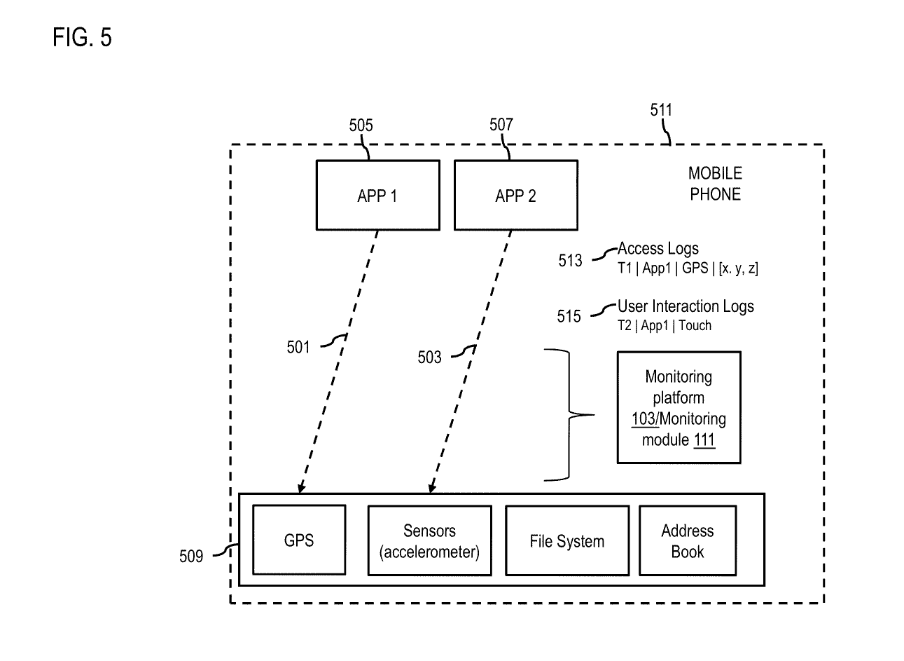

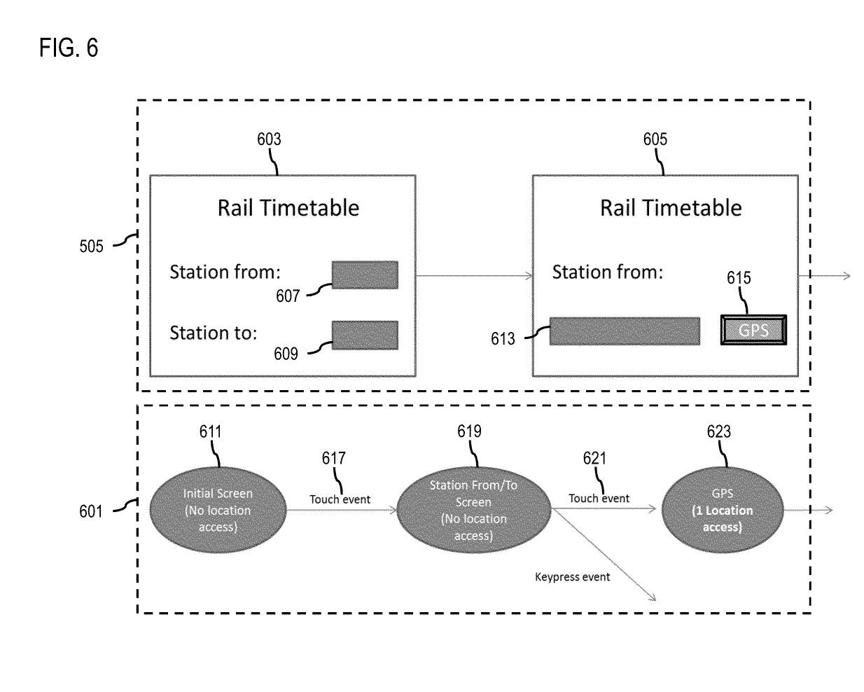

FIGS. 5 and 6 are diagrams of example data flows utilized in the processes of FIGS. 3 and 4, according to various embodiments. As shown, FIG. 5 illustrates an embodiment of the monitoring platform 103/monitoring module 111 determining one or more access requests by one or more applications. More specifically, the monitoring platform 103 determines the access requests 501 and 503, of the applications 505 (e.g., “APP 1”) and 507 (e.g., “APP 2”), respectively, to the resources 509 (e.g., GPS, sensors, file system, address book, etc.) of the device 511 (e.g., a mobile phone). In one embodiment, the monitoring platform 103 next causes, at least in part, a creation of at least one access log 513 and at least one user interaction log 515 of the access requests 501 and 503 during at least one run-time of the applications 505 and 507. In particular, the monitoring platform 103 intercepts one or more accesses (e.g., access request 501) by the application 505 to the sensitive resources of the device 511 (e.g., a mobile phone) such as a GPS receiver. Moreover, the at least one access log 513 created by the monitoring platform 103 includes, at least in part, the following information and/or format: timestamp (e.g., “T1”), application (e.g., application 505/“App 1”), resource accessed (e.g., “GPS”), and value (e.g., “[x, y, z]”). At substantially the same time, the monitoring platform 103 also logs any user interaction events (e.g., a key press, a touch, etc.) and creates the at least one user interaction log 515 that includes, at least in part, the following information and/or format: timestamp (e.g., “T2”), application (e.g., application 505/“App 1”), and event type (e.g., “Touch”). In one embodiment, once the monitoring platform causes, at least in part, the creation of the at least one access log 513, the at least one user interaction log 515, or a combination thereof, the monitoring platform 103 determines at least one events profile for the application 505. As previously discussed, while the monitoring platform 103 may model the at least one events profile in a number of ways (e.g., FSM, workflow, Petri net, etc.), in this example use case, the monitoring platform 103 models the at least one events profile as an FSM as depicted in FIG. 6.

As shown, FIG. 6 illustrates an embodiment of at least one events profile FSM determined by the monitoring platform 103. More specifically, at least one events profile FSM 601 may follow the screen flow (e.g., screens 603 and 605) of the application 505 (e.g., a Train Timetable application). By way of example, the initial screen 603 of the Train Timetable application 505 depicts input fields 607 and 609 for designating the “Station from” and the “Station to,” respectively. At this instance, the FSM 601 may capture that no location access was requested by the application 505 as depicted by the information bubble 611. Once a user clicks the “Station from” input field 613, a new screen (e.g., screen 605) is displayed that includes an input field 613 for entering the name of the “Station from” (e.g., New York Penn Station) and an adjacent “GPS” button 615. At this instance, the FSM 601 captures the selection of the “Station from” input field 607 by the user as a touch event 617 and the new screen is depicted by the information bubble 619. If the user selects the “GPS” button 615 (e.g., touch event 621), the application 505 will make a location request of the one or more resources of the device (e.g., a GPS receiver) as depicted by the information bubble 623. In particular, the events profile FSM 601 can capture whether the application 505 made the access request in response to a single touch event (e.g., touch event 617) or in response to multiple touch events (e.g., touch events 617 and 621). If the application 505 makes a location request after having received only one click or selection by the user (e.g., touch event 617), then that request can be captured by the events profile FSM 601 and later classified by the monitoring platform 103 as a malicious request.

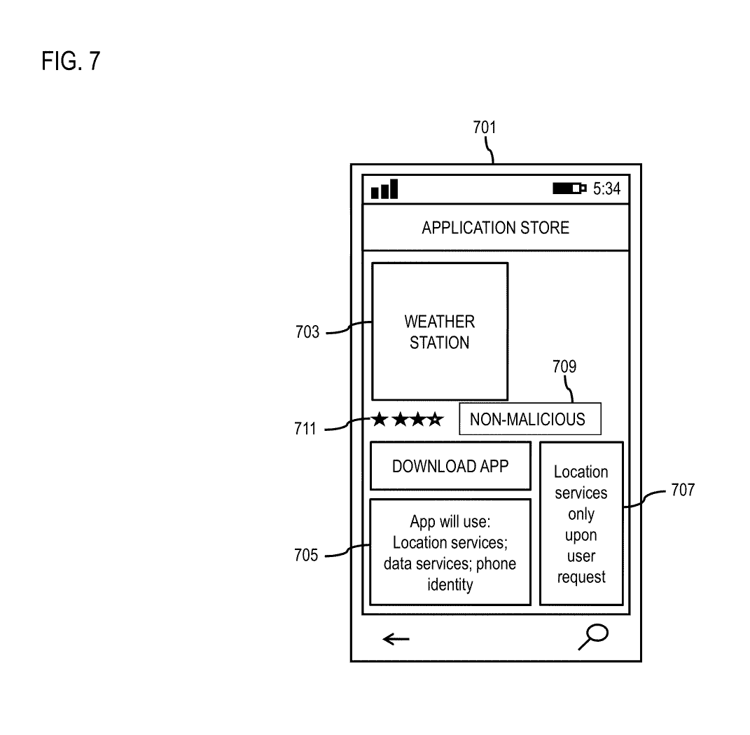

FIG. 7 is a diagram of a user interface utilized in the processes of FIGS. 3 and 4, according to various embodiments. As shown, the example user interface of FIG. 7 includes one or more user interface elements and/or functionalities created and/or modified based, at least in part, on information, data, and/or signals resulting from the processes (e.g., processes 300 and 400) described with respect to FIGS. 3 and 4. More specifically, FIG. 7 illustrates a user interface 701 depicting an application 703 (e.g., a weather application) of an Application Store. As previously discussed, in one embodiment, the system 100 first determines one or more access requests by at least one application (e.g., application 703) to one or more resources of at least one device (e.g., interface 701). In this example use case, the system 100 determined that the application 703 in at least one run-time will access the location services, the data services, and/or the phone identity information of the interface 701 as depicted in the information box 705. As illustrated by the information box 707, the system 100 also categorized the one or more access requests of the application 703 as user-initiated access requests (i.e., in response to an explicit user request). Consequently, the system 100 assessed the application 703 based, at least in part, on this categorization. In this example use case, the system 100 determined that because the one or more sensitive resources of the phone (e.g., location services) will only be accessed upon an explicit user request, the application 703 was determined to be a non-malicious application as depicted in the information box 709. As previously discussed, an application developer or a centralized application store (e.g., as depicted in interface 701) may include the assessment by the system 100 (e.g., information box 707) in its description of the application 703 to provide users with an additional layer of information and/or protection by informing the users that the application 703 will access certain resources only upon a user's request. As a result, the system 100 can assess and/or rate (e.g., ratings 711) the application 703 in a user-independent fashion.

The processes described herein for categorizing user-initiated and application-initiated access to device resources may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

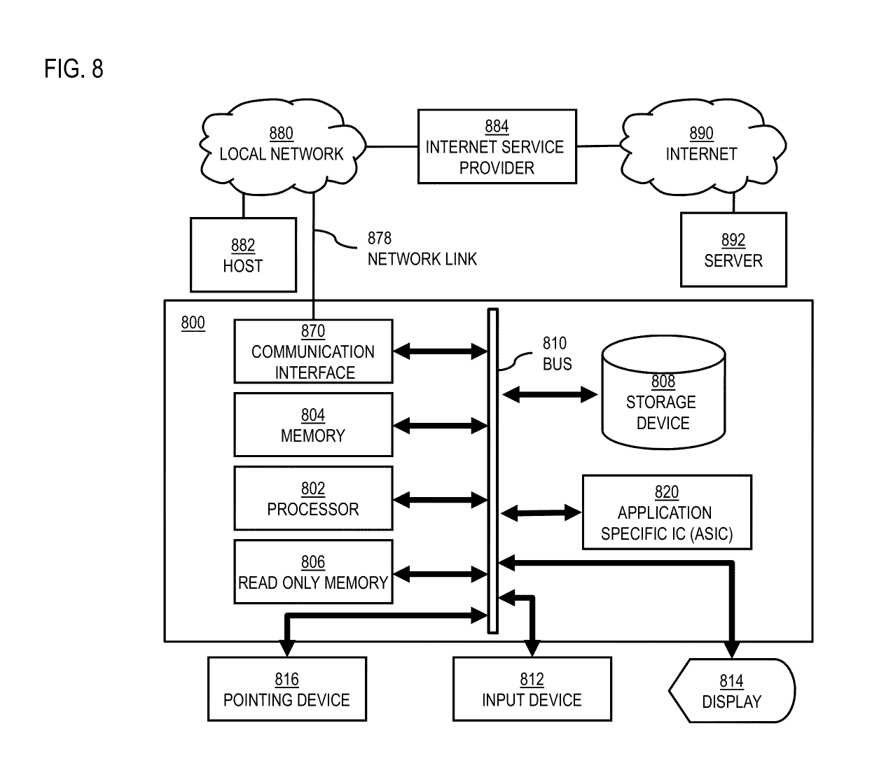

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to categorize user-initiated and application-initiated access to device resources as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of categorizing user-initiated and application-initiated access to device resources.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to categorize user-initiated and application-initiated access to device resources. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for categorizing user-initiated and application-initiated access to device resources. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for categorizing user-initiated and application-initiated access to device resources, is provided to the bus 810 for use by the processor from an external input device 812, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for categorizing user-initiated and application-initiated access to device resources to the UEs 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to categorize user-initiated and application-initiated access to device resources as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of categorizing user-initiated and application-initiated access to device resources.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to categorize user-initiated and application-initiated access to device resources. The memory 905 also stores the data associated with or generated by the execution of the inventive steps.

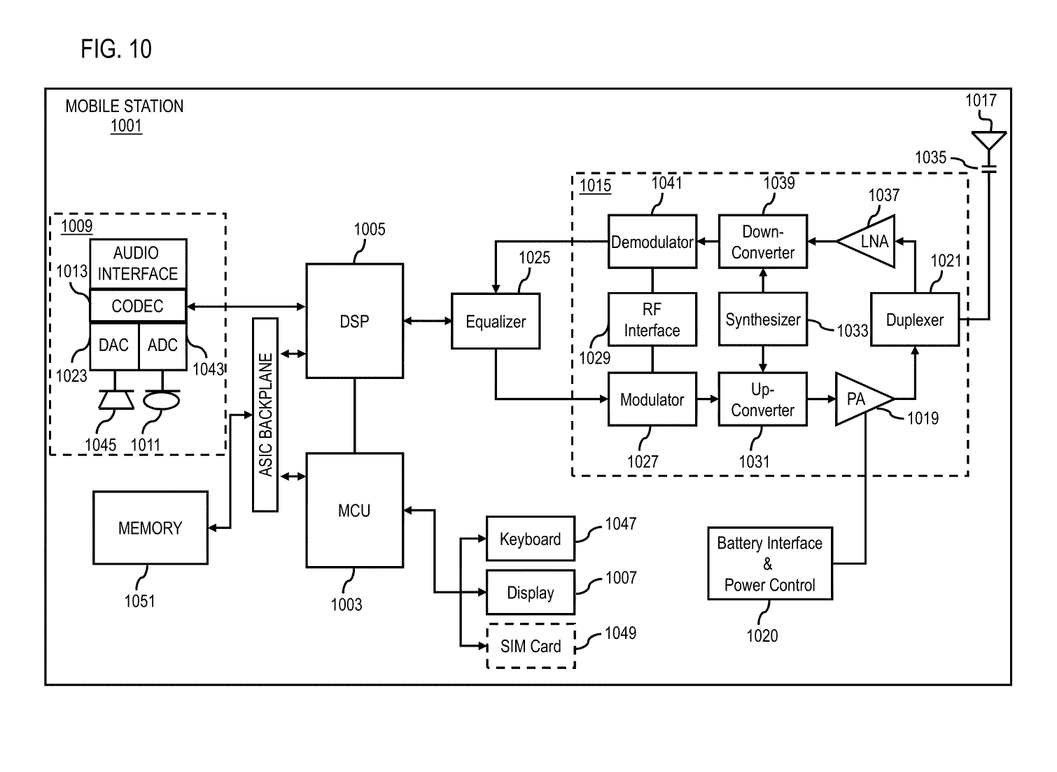

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of categorizing user-initiated and application-initiated access to device resources. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of categorizing user-initiated and application-initiated access to device resources. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to categorize user-initiated and application-initiated access to device resources. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of one or more access requests by at least one application to one or more resources of at least one device;
a processing of the one or more access requests to cause, at least in part, a categorization of the one or more access requests based, at least in part, on whether the one or more access requests were initiated by a user of the at least one device; and
an assessment of the at least one application based, at least in part, on the categorization.

2. A method of claim 1, wherein the (1) data and/or (2) information and/or (3) at least one signal are further based, at least in part, on the following:
an analysis of whether the one or more access requests are made via one or more user-specific application programming interfaces, one or more application-specific application programming interfaces, or a combination thereof,
wherein the categorization is based, at least in part, on the analysis.

3. A method of claim 1, wherein the (1) data and/or (2) information and/or (3) at least one signal are further based, at least in part, on the following:
a creation of at least one access log of the one or more access requests during at least one run-time of the at least one application;
a creation of at least one user interaction log of one or more user interaction events occurring during the at least one run-time; and
a processing of the at least one access log, the at least one user interaction log, or a combination thereof to cause, at least in part, the categorization.

4. A method of claim 3, wherein the (1) data and/or (2) information and/or (3) at least one signal are further based, at least in part, on the following:
at least one determination of at least one events profile for the at least one application based, at least in part, on the at least one access log, the at least one user interaction log, or a combination thereof,
wherein the categorization is based, at least in part, on the at least one events profile.

5. A method of claim 4, wherein the (1) data and/or (2) information and/or (3) at least one signal are further based, at least in part, on the following:
a modeling of the at least one events profile as a finite state machine.

6. A method of claim 4, wherein the (1) data and/or (2) information and/or (3) at least one signal are further based, at least in part, on the following:
the categorization of the one or more access requests during the at least one run-time based, at least in part, on the at least one events profile.

7. A method of claim 5, wherein the (1) data and/or (2) information and/or (3) at least one signal are further based, at least in part, on the following:
a transmission of the at least one events profile to the at least one device based, at least in part, on an installation, an update, an initialization, or a combination thereof of the at least one application at the at least one device.

8. A method of claim 4, wherein the (1) data and/or (2) information and/or (3) at least one signal are further based, at least in part, on the following:
at least one determination of one or more other events profiles, one or more other access logs, one or more other user interaction logs, or a combination thereof associated with the at least one application from one or more other users, historical information, or a combination thereof,
wherein the at least one events profile is based, at least in part, on the one or more other events profiles, the one or more other event logs, the one or more other user interaction logs, or a combination thereof.

9. A method of claim 1, wherein the assessment includes, at least in part, an intrusiveness assessment, a privacy assessment, a security assessment, or a combination thereof associated with the at least one application.

10. A method of claim 1, wherein the (1) data and/or (2) information and/or (3) at least one signal are further based, at least in part, on the following:
at least one determination of one or more access rights, one or more privacy policies, one or more security policies, or a combination thereof for the at least one application, the at least one device, or a combination thereof based, at least in part, on the assessment.

11. An apparatus comprising:
at least one processor; and
at least one memory including computer program code for one or more programs,
the at least one memory and the computer program code configured to, with the at least one processor, cause the apparatus to perform at least the following,
determine one or more access requests by at least one application to one or more resources of at least one device;
process and/or facilitate a processing of the one or more access requests to cause, at least in part, a categorization of the one or more access requests based, at least in part, on whether the one or more access requests were initiated by a user of the at least one device; and
cause, at least in part, an assessment of the at least one application based, at least in part, on the categorization.

12. An apparatus of claim 11, wherein the apparatus is further caused to:
cause, at least in part, an analysis of whether the one or more access requests are made via one or more user-specific application programming interfaces, one or more application-specific application programming interfaces, or a combination thereof,
wherein the categorization is based, at least in part, on the analysis.

13. An apparatus of claim 11, wherein the apparatus is further caused to:
cause, at least in part, a creation of at least one access log of the one or more access requests during at least one run-time of the at least one application;
cause, at least in part, a creation of at least one user interaction log of one or more user interaction events occurring during the at least one run-time; and
process and/or facilitate a processing of the at least one access log, the at least one user interaction log, or a combination thereof to cause, at least in part, the categorization.

14. An apparatus of claim 13, wherein the apparatus is further caused to:
determine at least one events profile for the at least one application based, at least in part, on the at least one access log, the at least one user interaction log, or a combination thereof,
wherein the categorization is based, at least in part, on the at least one events profile.

15. An apparatus of claim 14, wherein the apparatus is further caused to:
cause, at least in part, a modeling of the at least one events profile as a finite state machine.

16. An apparatus of claim 14, wherein the apparatus is further caused to:
cause, at least in part, the categorization of the one or more access requests during the at least one run-time based, at least in part, on the at least one events profile.

17. An apparatus of claim 15, wherein the apparatus is further caused to:
cause, at least in part, a transmission of the at least one events profile to the at least one device based, at least in part, on an installation, an update, an initialization, or a combination thereof of the at least one application at the at least one device.

18. An apparatus of claim 14, wherein the apparatus is further caused to:
determine one or more other events profiles, one or more other access logs, one or more other user interaction logs, or a combination thereof associated with the at least one application from one or more other users, historical information, or a combination thereof,
wherein the at least one events profile is based, at least in part, on the one or more other events profiles, the one or more other event logs, the one or more other user interaction logs, or a combination thereof.

19. An apparatus of claim 11, wherein the assessment includes, at least in part, an intrusiveness assessment, a privacy assessment, a security assessment, or a combination thereof associated with the at least one application.

20. An apparatus of claim 11, wherein the apparatus is further caused to:
determine one or more access rights, one or more privacy policies, one or more security policies, or a combination thereof for the at least one application, the at least one device, or a combination thereof based, at least in part, on the assessment.

21-48. (canceled)
